(19) United States
(12) Patent Application Publication
(10) Pub. No.: US 2006/0276333 A1
(43) Pub. Date: Dec. 7, 2006

(54) Agent for adsorbing protein from protein-containing liquids in the foood sector

(76) Inventor: Ulrich Sohling, Freising (DE)

Correspondence Address: Scott R Cox, Suite 2100, 500 W Jefferson St, Ouisville, KY, 40202, US

(21) Appl. No.: 10/556,761

(22) PCT Filed: Feb. 20, 2004
(86) PCT No.: PCT/EP04/01688

§ 371 Date: Jul. 11, 2006

(30) Foreign Application Priority Data
May 25, 2003 (DE) 10323499.3
May 25, 2003 (DE) 20308122.6

(51) Int. Cl. B01J 20/00

(52) U.S. Cl. 502/407

(57) ABSTRACT

A description is given of an agent, in particular for adsorbing protein from protein-containing liquids in the food sector, comprising at least one smectitic layered silicate having a total cation exchange capacity of about 30 to 120 mVal/100 g, characterized in that the content of potassium ions is less than 50%, preferably less than 40%, but more than 8%, preferably more than 12%, of the total cation exchange capacity of the layered silicate. In addition, a description is given of a method for producing an adsorption agent, and also its preferred use.

The invention relates to an agent, in particular for the adsorption of protein from protein-containing liquids in the food sector, based on smectitic layered silicates, in particular based on bentonite.

The term “protein-containing liquids in the food sector”, from which proteins are to be adsorbed advantageously using the inventive agent, comprises primarily white wines. Removal of residual protein from red wine or other wines, fruit juices, vinegar and beer is likewise possible. In addition, sauces, such as Asian fish sauces, can be clarified by adsorption of the residual protein. Protein is taken to mean here generally protein- or oligopeptide-containing substances and materials.

Customarily, for protein stabilization of white wines, in many countries natural sodium bentonites are used. Typical representatives thereof are what are termed Wyoming bentonites. The use of these bentonites is regulated by the international oenological codex (IOC) which limits the extraction of heavy metals from the bentonite in a 1% citric acid solution as a model substance for wine. For instance, the extraction of lead is to be <20 ppm, and the extraction of arsenic <4 ppm. Further details regulate extraction of magnesium and calcium, and also the contents of soluble iron. There are no IOC restrictions for the extraction of sodium. However, a number of countries, eg Germany, Austria or Italy, have national legislation which restricts sodium extraction, because excessive sodium contents can adversely affect the taste of the wine.

The extraction of sodium from bentonites may be decreased, for example, by using natural bentonites containing alkaline earth metals, eg calcium and/or magnesium bentonites. However, owing to their lower swelling capacity, these bentonites exhibit a lower protein adsorption compared with natural sodium bentonites for the same amount used. This may be explained by the fact that the calcium bentonites can never be completely delaminated into colloidal bentonite platelets but, on dispersion, form stacks of bentonite platelets which in total have a lower specific surface area available for adsorbing colloidal protein.

Compromise solutions with respect to the protein adsorption capacity on the one hand and the extraction of sodium, potassium and heavy metal ions on the other, may be achieved by making use of natural sodium bentonites, calcium bentonites and magnesium bentonites which have a lower sodium content than, for example, Wyoming bentonites, or by activating calcium bentonites using sodium carbonate in the prior art. As a result, the available calcium ions are precipitated as calcium carbonate and a sodium bentonite structure forms which is more readily dispersible and has a higher protein adsorption capacity. In the course of these activations, it is found that the highest protein adsorption capacity is achieved when the bentonite is activated using the stoichiometric amount of sodium carbonate equivalent to the cation exchange capacity. However, this leads in turn to the fact that the bentonite displays a greatly increased extraction of sodium ions.

The company Laviosa Chimica Mineraria S.p.A., Livorno, Italy, under the trade names “Enobent® GK” and “Enobent® K”, offers bentonites for the adsorption of protein from protein-containing drinks, such as wines and fruit juices, which have a low content of exchangeable sodium ions and a high content of exchangeable potassium ions. According to chemical analysis, these bentonites contain 3.75% by weight of K₂O and 0.48% by weight of Na₂O. The total cation exchange capacity (IUF; CEC) is 52 mVal/100 g, determined by the analysis method described below (IUF analysis). The contents of metal ions extractable by tartaric acid are reported in table 1.

TABLE 1
Content of soluble metals in wine bentonite
from Laviosa Chimica Mineraria S.p.A., determined by
extracting with 1% strength tartaric acid as specified
by the German Wine Act (see below), based on bentonite
having 10% moisture content

| Element | Amount |
|---|---|
| Arsenic (ppm) | 1.5 |
| Lead (ppm) | 2 |
| Aluminum (% by weight) | 0.05 |
| Calcium (% by weight) | 0.57 |
| Iron (% by weight) | 0.03 |
| Magnesium (% by weight) | 0.18 |
| Sodium (% by weight) | 0.44 |
| Potassium (% by weight) | 1.7 |

The content of exchangeable potassium ions which can be determined by the IUF analysis described in more detail hereinafter is 36 mVal/100 g, the content of sodium ions 17 mVal/100 g. The content of exchangeable potassium ions is thus 69% of the total cation exchange capacity.

On extraction with tartaric acid (see above) the content of exchangeable potassium was determined at 1.7% by weight. This is equivalent to 43 mVal/100 g, that is 83% of the total cation exchange capacity. This means that the Laviosa bentonite has high potassium contents. The high content of potassium ions is undesirable to the extent that in the wine, this can lead to the formation of relatively large amounts of potassium tartrate (tartar).

The object underlying the invention is to develop an agent, in particular for adsorbing protein from protein-containing liquids, in particular drinks, based on smectitic layered silicates, which agent has a high activity in the removal of colloidally dispersed proteins, but, during the drinks treatment, releases only small amounts of metal ions, in particular potassium ions and sodium ions.

The invention thus relates to a smectitic layered silicate or adsorption agent as claimed in claim 1.

“Total cation exchange capacity” (IUF) is taken to mean the sum of all exchangeable cations reported in mVal/100 g and determined by the IUF analytical method as described hereinafter before the example section (IUF analysis). The total cation exchange capacity therefore comprises, for example, the sum of all exchangeable ions of calcium, magnesium, sodium and potassium. To determine the total cation exchange capacity, the bentonite is treated with an ammonium chloride solution. In this procedure, because of the high affinity of the ammonium ions for the bentonite, virtually all exchangeable cations are exchanged for ammonium ions. After separation and washing, the nitrogen content of the bentonite is determined and the content of ammonium ions calculated therefrom.

A stoichiometric activation (treatment) here is taken to mean an activation or treatment with an amount of potassium ions and/or sodium ions which corresponds to the difference between the total cation exchange capacity (IUF) and the amount of monovalent cations already present in the starting material. The total cation exchange capacity only corresponds to a stoichiometric activation when the smectitic layered silicate contains eg only magnesium ions and calcium ions as exchangeable cations. However, natural bentonites frequently also contain sodium and in rare cases also some potassium as exchangeable cations. The amount of potassium ions or sodium ions required for a stoichiometric activation is calculated from the total cation exchange capacity minus the amount of exchangeable sodium ions and if appropriate potassium ions in the non-activated layered silicate. In the case of inventive agent for adsorbing protein, when alkaline-earth-metal-containing layered silicates are used, for example only a fraction of the exchangeable alkaline earth metal ions can be replaced by potassium, ie the activation proceeds substoichiometrically.

Surprisingly, it has been found that in the case of an activation (treatment) of the smectitic layered silicate with potassium carbonate, in contrast to activation with sodium carbonate alone, the maximum of the adsorption capacity is already achieved at amounts of potassium carbonate added which are below the stoichiometric amount based on the cation exchange capacity of the smectitic layered silicate for alkaline earth metals. A particularly high adsorption capacity of the layered silicate is achieved when the content of exchangeable potassium ions is less than 50%, preferably less than 40%, but more than 8%, preferably more than 12%, of the total cation exchange capacity of the layered silicate. By this means it is possible to provide a highly active adsorption agent which exhibits a low extraction of potassium or sodium ions. The high activity, in addition, leads to the extraction of other heavy metal ions being minimized, since this extraction, to a first approximation, is independent of the degree of activation. The exchangeable cations, in particular the potassium and sodium ions, are determined in each case as stated hereinafter under the analytical method (see IUF analysis).

Preferably, the smectitic layered silicate is a montmorillonite-containing layered silicate, in particular a bentonite. In addition to bentonites, use can also be made of other smectitic layered silicates, such as hectorite and nontronite. Mixtures of the above materials can also be used.

The smectitic layered silicates generally, but not obligatorily, have a total cation exchange capacity of about 30 to 120 mVal/100 g, preferably about 40 to 110 mVal/100 g.

In the context of the present invention, it has also been found that in the activation or treatment of the layered silicate with a mixture of potassium carbonate and sodium carbonate, an additional synergistic effect occurs. For instance, the adsorption performance in the case of treatment with very low substoichiometric amounts of potassium carbonate and sodium carbonate was significantly above the result which would be expected on account of the values in the case of activation with in each case only the same amounts of sodium carbonate or potassium carbonate alone. For instance, as stated above, a small substoichiometric amount of sodium carbonate leads to only a very small increase of the adsorption ability of the layered silicate. If the same small amount of sodium carbonate, however, is combined with a substoichiometric amount of potassium carbonate, it has a substantially greater effect on the adsorption performance of the layered silicate. According to a preferred inventive aspect, the quantitative ratio between the potassium carbonate used and the sodium carbonate used is therefore between about 4:1 and about 1:4, preferably between about 2:1 and 1:2.

According to a preferred embodiment of the invention, the total content of the treated (activated) layered silicate of exchangeable potassium and sodium ions together is less than 90%, preferably less than 80%, of the total ion exchange capacity of the layered silicate.

According to a further preferred embodiment of the invention, the content of exchangeable potassium ions or the total content of exchangeable potassium ions and sodium ions is less than about 80% of the stoichiometric exchange amount of the layered silicate used as starting material. Therefore, preferably, significantly substoichiometric amounts of potassium ions and if appropriate sodium ions are used for treating the layered silicate.

According to a further aspect, the invention relates to an adsorption agent, the content of exchangeable sodium ions being less than 70%, preferably less than 60%, in particular preferably less than 40%, of the total ion exchange capacity of the layered silicate.

According to a further aspect, the present invention also relates to a method for producing a smectitic layered silicate or an adsorption agent, in particular for adsorbing protein from protein-containing liquids in the food sector, at least one smectitic layered silicate being treated with potassium carbonate and if appropriate sodium carbonate until the content of exchangeable potassium ions is less than 50%, preferably less than 40%, but more than 8%, preferably more than 12%, of the total cation exchange capacity of the layered silicate.

As stated above, therefore, according to the invention, preferably, use is made of significantly substoichiometric amounts of potassium ions and if appropriate sodium ions for treating the layered silicate. Preferably, the content of exchangeable potassium ions or the total content of exchangeable potassium ions and sodium ions is less than about 80% of the stoichiometric exchange amount of the layered silicate used as starting material.

In the treatment or activation of the layered silicate, the contacting can be performed in any manner familiar to the those skilled in the art, eg by producing a solid mixture, a suspension with the layered silicate and the potassium carbonate and if appropriate the sodium carbonate, or charging or spraying the layered silicate with a solution of the potassium carbonate and if appropriate the sodium carbonate. The amounts of potassium carbonate or sodium carbonate to be used in order to achieve the desired contents of exchangeable potassium ions or sodium ions in the inventive agent may be readily calculated or determined by routine experiments.

A further aspect of the present invention relates to the use of the inventive smectitic layered silicate or the agent for removing protein from protein-containing liquids in the food sector, in particular from wine, particularly preferably from white wine. However, other uses of the inventive layered silicate or agent are explicitly not excluded.

According to the invention, the following analytical methods were used:

a) Determination of the Total Cation Exchange Capacity (IUF Analysis)

To determine the total cation exchange capacity (IUF, CEC), the layered silicate under study was dried at 150° C. over a period of two hours. Thereafter, the dried material was reacted with an excess of aqueous 2N NH₄Cl solution for one hour under reflux. After a standing time of 16 hours at room temperature, the mixture was filtered, the filtercake was washed, dried and ground, and the NH₄ content in the layered silicate determined by nitrogen determination (CHN analyzer from Leco). The amount and type of exchangeable metal ions (“exchangeable cations”) was determined by spectroscopy in the filtrate as specified in DIN 38406, part 22.

b) Determination of Cations Extractable by 1% Tartaric Acid

The method for determining the extractable cations is described in the German Wine Regulations of Aug. 22, 1990 and serves for determining the tartaric-acid-soluble contents of sodium, calcium, magnesium, iron, arsenic, lead and ash in wine bentonites. The limit values permissible for extractable metal ions are stated in table 2. The determination was carried out according to the invention as in the German Wine Regulations, schedules 2 and 3, text A 401, July 1997, EL 97, p. 40, “Reinheitsanforderungen fur Bentonit” [Purity requirements for bentonite].

TABLE 2
Limit values for extractable metal ions
according to the German Wine Regulations (based on
bentonite having 10% moisture content)

| Element | Limit value |
|---|---|
| Sodium (% by weight) | 0.5 |
| Calcium (% by weight) | 0.8 |
| Magnesium (% by weight) | 0.5 |
| Iron (% by weight) | 0.2 |
| Lead (ppm) | 20.0 |
| Arsenic (ppm) | 2.0 |

c) Determination of Protein Adsorption

To study the effect of bentonites for removing residual protein from white wine, a method was employed which is marketed by Wein- und Bodenlabor Dr. Karl-Heinz Nilles, Volkach. Dr. Nilles reagent 1 (blank) and Dr. Nilles reagent 2 were used in accordance with the manufacturer's information and instructions for determining the protein adsorption capacity. The method is based on precipitation of wine protein using a protein-specific reagent with subsequent photometric turbidity measurement of the colorless protein precipitation at a wavelength of 623 nm. The residual protein remaining in the wine after treatment is determined.

For this the bentonite is predispersed in mains water and added to the white wine in appropriate amounts. Typically, the concentration range of 50 g to 200 g of bentonite/hl of wine is studied here. After an exposure time of 15 min, the bentonite is centrifuged off and the residual protein content is determined photometrically from the extinction using the protein test from Dr. Nilles. To show a graph of the residual protein as a function of bentonite addition, the extinction was plotted as a function of bentonite addition. If all of the residual protein is removed, a plateau is formed at low extinction coefficients, which correspond to the instrument resolution (about 0.01). This method was used for all studies described hereinafter of clarification properties of the inventive bentonites and also the comparative examples.

For the test of the clarification action of the bentonites, a wine not refined with bentonite was used: 1999 Eschendorfer Lump, Silvaner dry, from the Rainer Sauer vineyard, Eschendorf.

Production of the inventive agents is described hereinafter for the example of bentonites as the preferred representative of smectitic layered silicates.

1. Activation

a) Activation of Bentonites by Exchangeable Alkaline Earth Metals (Ca/Mg Bentonites); Method Variant (a)

According to the first method variant (a), a calcium-containing raw bentonite having a water content of about 30 to 35% by weight was kneaded together with solid sodium carbonate (comparison) and potassium carbonate (invention), dried and ground. The raw bentonite was precrushed to pieces of less than 3 cm in diameter. If the raw bentonite did not have the stated water content, this was established by spraying with water.

The activation was performed in detail as follows: 350 g of raw bentonite having a water content of about 30 to 35% by weight were placed into a mixing apparatus (eg a Werner & Pfleiderer mixer (kneader)) and kneaded for 1 minute. Then, with the mixing apparatus continuing to run, the appropriate amount of sodium carbonate (for the comparative experiments) or potassium carbonate, if appropriate together with sodium carbonate (for the inventive products) was added and the mixture was kneaded for a further 10 min. Various amounts of sodium carbonate or potassium carbonate were added in accordance with the examples hereinafter, the amounts added being based on the anhydrous bentonite. In addition, some distilled water was added as required, so that the kneading mass “shears” well.

The kneading mass was thereafter comminuted into small pieces and dried in a circulated air drying cabinet at about 75° C for 2 to 4 hours to a water content of 10±2%. The dried material was then ground in a rotor beater mill (eg in a Retsch mill) over a 0.12 mm screen.

b) Activation of Bentonites by Exchangeable Alkali Metals (Na Bentonites); Method Variant (b)

According to the second method variant (b), the sodium-carbonate-activated bentonite obtained according to (a) as comparison substance was kneaded with solid potassium carbonate at a moisture content of about 15 to 40% by weight, dried and ground, in detail, the procedure similar to method variant (a) being used.

### EXAMPLES

### Example 1

### Activation of a Natural Bentonite (Bentonite 1) by Potassium Carbonate or Sodium Carbonate

As starting bentonite for example 1, use was made of a natural Ca/Mg bentonite (product name EX 0242, obtainable from Sud-Chemie AG; hereinafter called “bentonite 1” which has the characteristic data given in column 2 of table 3.

TABLE 3
Total cation exchange capacity (IUF) of
bentonite 1

| | Cation exchange capacity |
|---|---|
| Element | [mVal/100 g] |
| Sodium | 15 |
| Potassium | 5.1 |
| Magnesium | 21 |
| Calcium | 60 |
| Total | 83 |

The bentonite 1 was used to produce bentonite powders which are activated both stoichiometrically and substoichiometrically (see above). In the case of activation by sodium carbonate, a superstoichiometrically activated sample was also produced. Since bentonite 1 already contains small amounts of exchangeable sodium and potassium, the stoichiometric amount of sodium ions or soda or potassium ions or potassium carbonate is given by the difference between total cation exchange capacity and the cation exchange capacity for sodium and potassium. The stoichiometric exchange amount is 61 mVal/100 g. This is equivalent to an amount of 3.2% by weight of soda or 4.2% by weight of potassium carbonate.

To convert the natural calcium bentonite into a sodium bentonite, it was kneaded as raw clay (=non-activated bentonite) with soda. Converting the concentration of exchangeable calcium ions to mol/kg of bentonite, this produces 0.3 mol of Ca²⁺/kg of bentonite. To achieve complete exchange of Ca²⁺ against Na⁺ requires activation by 3.2% by weight of anhydrous sodium carbonate (molar mass 106 g/mol). If activation by K₂CO₃ is carried out (molar mass 138.2 g/mol), complete exchange of Ca²⁺ against K⁺ requires 4.2% by weight of potassium carbonate (anhydrous).

The abovedescribed natural bentonite was activated as described above using the amounts of sodium carbonate or potassium carbonate stated in tables 4 and 5.

TABLE 4
Degrees of activation set in the activation by
sodium carbonate (comparison)

| Amount of sodium | |
|---|---|
| carbonate used | Fraction of the stoichiometric |
| (% by weight) | amount of sodium ions (%) |
| 2.2 | 70 (substoichiometric) |
| 3.2 | 100 (stoichiometric) |
| 4.2 | 130 (superstoichiometric) |

TABLE 5
Degrees of activation set in the activation by
potassium carbonate (according to the invention)

| Amount of | | | Content of |
|---|---|---|---|
| potassium | Fraction of the | Content of | exchangeable |
| carbonate | stoichiometric | exchangeable | potassium |
| used | amount of potassium | sodium ions | ions of the |
| (% by wt.) | ions (%) | of the IUF | IUF |
| 1 | 23 | 18 | 14 |
| | (substoichiometric) | | |
| 2 | 46 | 18 | 20 |
| | (substoichiometric) | | |
| 3 | 70 | 18 | 31 |
| | (substoichiometric) | | |
| 4.2 | 100 | 18 | 43 |
| | (stoichiometric) | | |

The contents of sodium or potassium ions given in table 5 are based on the total exchange capacity (IUF) of the finished adsorption agent, ie of the layered silicate treated by potassium carbonate or sodium carbonate.

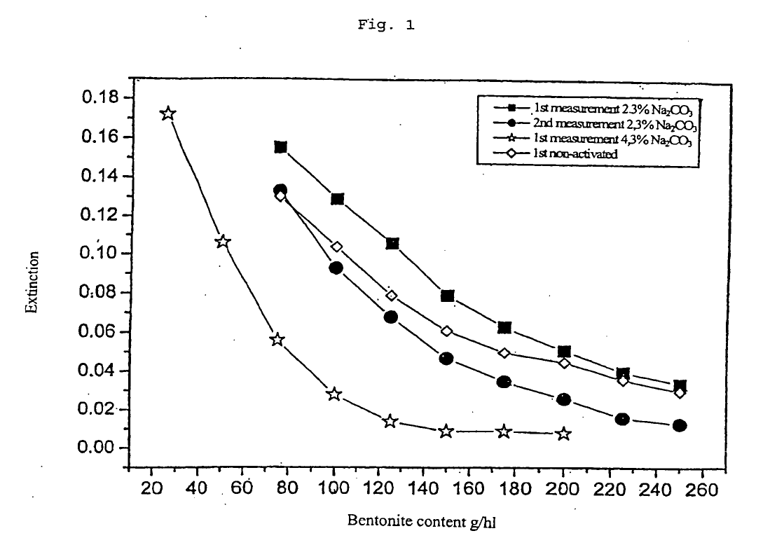

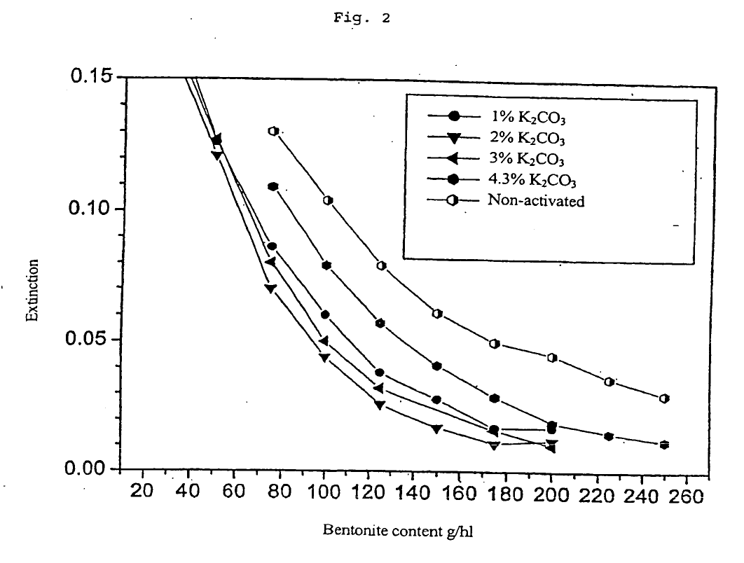

The raw bentonites activated by adding various amounts of alkali metal carbonates and ground (water content approximately 10% by weight) were used for a protein adsorption test according to Dr. Nilles. FIGS. 1 and 2 show the test results for activation by sodium carbonate and potassium carbonate. For comparison, in each case the curve of the non-activated bentonite is given.

As can be seen from FIG. 1 (comparison), the bentonite activated superstoichiometrically by 4.3% sodium carbonate displays the best protein adsorption properties. This is shown by the fact that, at low bentonite addition, less protein remains in the wine than when use was made of the same amounts of bentonite which was activated substoichiometrically or stoichiometrically.

A completely different picture results from the activation by potassium carbonate shown in FIG. 2. Here also, the adsorption capacity of the bentonite is improved by the activation. However, the maximum of the adsorption capacity is already reached degrees of activation far below the stoichiometric amount of potassium carbonate (4.2% by weight), based on exchangeable calcium ions in the bentonite. Owing to the lower potassium ion content of the bentonite, and also to the lower amount of the inventive bentonite which is required to achieve a certain result, it is possible to provide bentonites having high protein binding properties, compared with previously known activated drinks bentonites, significantly lower amounts of sodium or potassium ions being extracted. The advantage of the bentonite inventively substoichiometrically activated by potassium carbonate is also shown in the fact that, owing to the reduced dosage compared with natural bentonite, in use, fewer metals in addition to potassium are extracted, since this, to the first approximation, is independent of the degree of activation.

TABLE 6a
Fraction of soluble metals in bentonite 1,
determined by extraction by 1% strength tartaric acid
in accordance with the German Wine Regulations, based
on bentonite of 10% moisture content

| | | Activated | Activated | Activated |
|---|---|---|---|---|
| | Non- | by 2% | by 3% | by 4.3% |
| | activated | K₂CO₃ | K₂CO₃ | K₂CO₃ |
| Sodium | 0.44% | 0.54% | 0.55% | 0.57% |
| Calcium | 0.63% | 0.51% | 0.57% | 0.56% |
| Magnesium | 0.13% | 0.11% | 0.12% | 0.12% |
| Iron | 0.02% | <0.01% | <0.01% | <0.01% |
| Lead | 2.6 ppm | 3 ppm | 4 ppm | 3 ppm |
| Arsenic | 1.5 ppm | 1.6 ppm | 1.7 ppm | 1.7 ppm |
| Potassium | 0 | 0.75% | 1.12% | 1.55% |

The amounts of potassium introduced in the activation are given by table 6b hereinafter.

TABLE 6b
Amount of calcium ions introduced into
bentonite 1 by the activation, based on bentonite of
10% moisture content (water content)

| | | Activated | Activated | Activated |
|---|---|---|---|---|
| | Non- | by 2% | by 3% | by 4.3% |
| Bentonite 1 | activated | K₂CO₃ | K₂CO₃ | K₂CO₃ |
| Amount of | 0 | 1.12 | 1.68 | 2.4 |
| potassium | | | | |
| introduced | | | | |
| (% by wt.) | | | | |

As can be seen from table 6a, the extraction of metal from the drinks bentonites does not change significantly after activation by potassium carbonate. The exception is here, obviously, the potassium introduced on activation. However, the values given in table 6a and 6b show that less than 70% of the potassium introduced by the activation is extracted by 1% strength tartaric acid. On the other hand, however, after the activation, the protein adsorption capacity of the bentonite is greatly increased, so that for the same protein content in the wine, a lower dosage of the bentonite is required. Overall, as a result, the introduction of heavy metals to the wine is greatly reduced compared with use of a non-activated bentonite.

### Example 2

### Activation of a Bentonite Mixture (Bentonite 2) by Potassium Carbonate and Mixtures of Potassium Carbonate/Sodium Carbonate

A 1:1 mixture was produced from two non-activated bentonites, the product EX 0242 from example 1, and the product PERSTAB®, both obtainable from Suid-Chemie AG (hereinafter called “bentonite 2”). The data of the mixture are given in-table 9.

TABLE 9
Characteristic data of a 1:1 bentonite mixture
(bentonite 2)

| | |
|---|---|
| Total cation exchange capacity (IUF) | 96 mVal/100 g |
| Exchangeable sodium | 23 mVal/100 g |
| Exchangeable potassium | 4 mVal/100 g |
| Stoichiometric amount of potassium or | 69 mVal/100 g |
| potassium and sodium ions responsible | |
| for complete activation | |

Based on the bentonite, the stoichiometric amount of potassium carbonate, ie the amount which is required for complete activation, is 4.8% by weight.

The bentonite mixture was activated by potassium carbonate, and also by a mixture of potassium carbonate and sodium carbonate. The proportions used for the activation are given in table 10. The proportions are based in each case on bentonite of 10% moisture content.

TABLE 10
Proportions of activation reagents for
activating a bentonite mixture (bentonite 2)

| | Amount of | | Fraction of | | Content of | Content of |
|---|---|---|---|---|---|---|
| | activation | | the stoichiometric | | exchangeable | exchangeable |
| | agent | | amount | | sodium ions | potassium ions |
| No. | K₂CO₃ | Na₂CO₃ | K₂CO₃ | Na₂CO₃ | of the IUF | of the IUF |
| 1 | 3% by wt. | — | 63% | — | 24 | 30 |
| 2 | 1.5% by wt. | 1.5% by wt. | 31.5% | 41.6% | 49 | 16 |

The contents of sodium and potassium ions given in table 10 are based on the total cation exchange capacity (IUF) of the layered silicate treated with potassium carbonate and sodium carbonate.

The protein adsorption test of Dr. Nilles was carried out (see above) using the activated bentonite 2. It was found that on activation by a mixture of potassium carbonate and sodium carbonate, an additional synergistic effect occurs. For instance, the adsorption efficiency on treatment with in each case 1.5% by weight of potassium carbonate and sodium carbonate was significantly over the result which was to be expected on the basis of the values on activation with in each case only 1.5% by weight of sodium carbonate or 1.5% by weight of potassium carbonate alone. Thus, a substoichiometric amount of sodium carbonate (here: 1.5% by weight) leads to only a very low increase in protein adsorption capacity of the layered silicate. If the same amount of sodium carbonate is combined, however, with a substoichiometric amount of potassium carbonate (here: 1.5% by weight), it has a substantially greater effect on the protein adsorption performance of the layered silicate.

The fractions of extractable metal ions were determined in accordance with the German Wine Regulations (see above). The values found are given in table 11.

TABLE 11
Fraction of soluble metals in the activated
bentonite 2, determined by extraction by 1% strength
tartaric acid according to the German Wine Regulations,
based on bentonite of 10% by weight water content:

| | | | Activation by |
|---|---|---|---|
| | Non- | Activation | 1.5% K₂CO₃ and |
| Metal | activated | by 3% K₂CO₃ | 1.5% Na₂CO₃ |
| Sodium (% by wt.) | 0.68 | 0.66 | 0.5 |
| Calcium (% by wt.) | 0.42 | 1.9 | 1.2 |
| Magnesium (% by wt.) | 0.1 | 0.17 | 0.12 |
| Iron (% by wt.) | 0.03 | 0.04 | 0.02 |
| Lead (ppm) | 6 | 14 | 11 |
| Arsenic (ppm) | 1.3 | 1.7 | 1.5 |
| Potassium (% by wt.) | 0.1 | 0.9 | 0.5 |

In the diagrams:

FIG. 1 shows the protein adsorption of bentonite 1 (see example 1), activated (treated) with sodium carbonate. The percentages relate to % by weight. The extinction values plotted on the Y axis are dimensionless values which are obtained in the measurement (of Dr. Nilles) described in the analytical method section. The X axis gives the bentonite content used in g/hl to treated liquid;

FIG. 2 shows the protein adsorption of bentonite 1 for various degrees of activation by potassium carbonate. The percentages relate to % by weight. The extinction values plotted on the Y axis are dimensionless values which are obtained in the measurement (of Dr. Nilles) described in the analytical method section. The X axis gives the bentonite content used in g/hl to treated liquid;

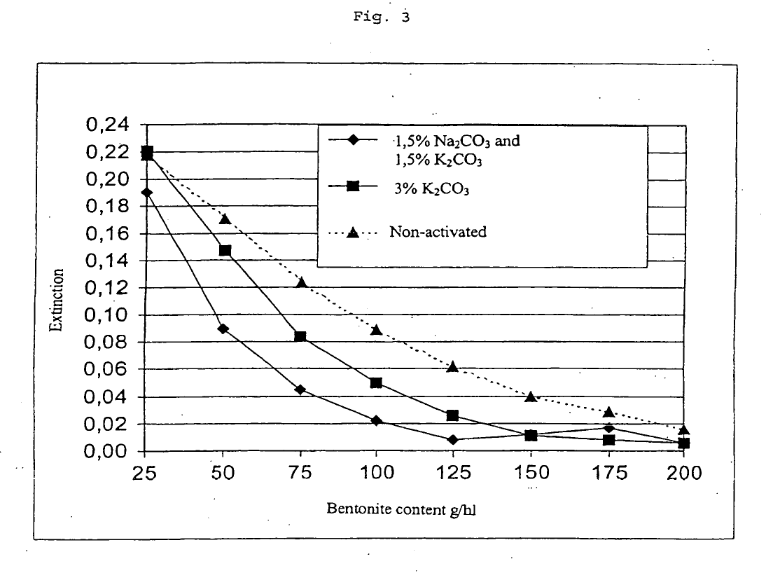

FIG. 3 shows measurement of the protein adsorption using the bentonite mixture of example 3. The percentages relate to % by weight. The extinction values plotted on the Y axis are dimensionless values which are obtained in the measurement (of Dr. Nilles) described in the analytical method section. The X axis gives the bentonite content used in g/hl to treated liquid.

1. A method for producing an adsorption agent, in particular for adsorbing protein from protein-containing liquids in the food sector, comprising treating a smectitic layered silicate with potassium carbonate and sodium carbonate in such a manner that the content of potassium ions in the layered silicate is less than 50%, but more than 8%, of the total cation exchange capacity of the layered silicate.

2. The method as claimed in claim 1, characterized in that the quantitative ratio between the potassium carbonate used and the sodium carbonate used is between 4:1 and 1:4.

3. The method as claimed in claim 1, characterized in that the potassium carbonate and the sodium carbonate used are solids and are kneaded with the smectitic layered silicate.

4. The method as claimed in claim 3, characterized in that the kneading is performed at a moisture content of the layered silicate between about 20 and 40% by weight.

5. The method as claimed in claim 3, characterized in that, after the kneading, the treated layered silicate is dried to a moisture content of about 10% and crushed or ground.

6. The method as claimed in claim 1, characterized in that exchangeable calcium and magnesium ions present in the smectitic layer silicate prior to treating comprise at least 30%, of the total cation exchange capacity of the layered silicate.

7. The method as claimed in claim 1, characterized in that, a total amount of potassium carbonate and sodium carbonate used for treating the layered silicate corresponds to less than 80% of the total ion exchange capacity of the layered silicate minus the content of exchangeable monovalent cations already present in the layered silicate before the treatment.

8. The method as claimed in claim 1, characterized in that the total amount of potassium carbonate and sodium carbonate used is more than 10%, of the total cation exchange capacity of the layered silicate minus the monovalent exchangeable cations already present in the layered silicate before the treatment.

9. The method as claimed in claim 1, characterized in that the content of potassium ions in the layered silicate is less than 40% of the total cation exchange capacity of the layered silicate.

10. The method as claimed in claim 1, characterized in that the content of potassium ions in the layered silicate is more than 12% of the total cation exchange capacity of the layered silicate.

11. The method as claimed in claim 1, characterized in that use is made of potassium carbonate and sodium carbonate in the form of a solution.

12. An agent, in particular for adsorbing protein from protein-containing liquids in the food sector, comprising at least one smectitic layered silicate treated with sodium carbonate and potassium carbonate wherein the smectitic layered silicate has a total cation exchange capacity of 30 to 120 mVal/100 g and is characterized in that the content of potassium ions in the layered silicate is less than 50%, but more than 8%, of the total cation exchange capacity of the layered silicate.

13. The agent as claimed in claim 12, characterized in that the smectitic layered silicate comprises a montmorillonite-containing layered silicate.

14. The agent as claimed in claim 12, characterized in that the cation exchange capacity of the smectitic layered silicate is about 40 to 110 mVal/100 g.

15. The agent as claimed in claim 12, characterized in that the content of exchangeable sodium ions is less than 70%, of the total ion exchange capacity of the layered silicate.

16. The agent as claimed in claim 12, characterized in that the total content of exchangeable potassium and sodium ions together is less than 90%, of the total ion exchange capacity of the layered silicate.

17. The agent as claimed in claim 12, wherein the total content of exchangeable potassium and sodium ions is less than about 80% of the stoichiometric exchange amount of the layered silicate used as starting material.

18. (canceled)
